(19) United States
(12) Patent Application Publication
(10) Pub. No.: US 2018/0051568 A1
(43) Pub. Date: Feb. 22, 2018

(54) ENGINE COMPONENT WITH POROUS HOLES

(71) Applicant: General Electric Company, Schenectady, NY (US)

(72) Inventor: Ronald Scott Bunker, Placitas, NM (US)

(21) Appl. No.: 15/238,113

(22) Filed: Aug. 16, 2016

(51) Int. Cl. F01D 5/18; F01D 9/06; F23R 3/00; F23R 3/06

(52) U.S. Cl. CPC F01D 5/186; F01D 9/065; F05D 2260/202; F23R 3/06; F05D 2220/32; F23R 3/002

(57) ABSTRACT

An apparatus and method for cooling an engine component, including an outer wall separating a hot fluid flow from a cooling fluid flow, using the cooling fluid flow to cool the engine component. A region in the component can include a plurality of film holes with a porous material to meter the flow of cooling fluid provided from the engine component.

### BACKGROUND OF THE INVENTION

Turbine engines, and particularly gas or combustion turbine engines, are rotary engines that extract energy from a flow of combusted gases passing through the engine onto a multitude of rotating turbine blades.

Turbine engines for aircraft, such as gas turbine engines, are often designed to operate at high temperatures to maximize engine efficiency, so cooling of certain engine components, such as the high-pressure turbine and the low-pressure turbine, can be beneficial. Typically, cooling is accomplished by ducting cooler air from the high and/or low-pressure compressors to the engine components that require cooling. Temperatures in the high-pressure turbine are around 1000° C. to 2000° C. and the cooling air from the compressor is around 500° C. to 700° C. While the compressor air is a high temperature, it is cooler relative to the turbine air, and can be used to cool the turbine.

Contemporary turbine components, such as blades, can include one or more interior cooling circuits for routing the cooling air through the component to cool different portions of the component, and can include dedicated cooling circuits for cooling different portions of the component, such as the leading edge, trailing edge, or tip of the blade.

### BRIEF DESCRIPTION OF THE INVENTION

In one aspect, embodiments of the invention relate to a component for a turbine engine, which generates a hot fluid flow and provides a cooling fluid flow. The component includes a wall separating the hot fluid flow from the cooling fluid flow and having a hot surface along with the hot fluid flow and a cooling surface facing the cooling fluid flow. The component further includes a cooling region defined in the hot surface. A plurality of holes extend between the cooling surface and the hot surface with at least some of the plurality of holes located within the cooling region. A first porous material fills at least some of the plurality of holes.

In another aspect, embodiments of the invention relate to an airfoil for a turbine engine including a perimeter wall bounding an interior and defining a pressure side and a suction side extending axially between a leading edge and a trailing edge, and extending between a root and a tip. The airfoil further includes a radially extending leading edge region disposed along the leading edge and at least partially extending between the root and the tip. A plurality of film holes are disposed in the leading edge region. A first porous material fills at least some of the film holes.

In yet another aspect, embodiments of the invention relate to a method of providing a cooling film along a leading edge region of an airfoil for a turbine engine. The method includes: (1) supplying cooling air to the interior of the airfoil; (2) exhausting at least a portion of the supplied cooling air through at least one film hole disposed in the leading edge region; and (3) exhausting the cooling air through the at least one film hole by passing the cooling air through a first porous material in the film hole.

### BRIEF DESCRIPTION OF THE DRAWINGS

In the drawings:

FIG. 1 is a schematic cross-sectional diagram of a gas turbine engine for an aircraft.

FIG. 2 is a perspective view of an engine component of the gas turbine engine of FIG. 1 illustrated as an airfoil.

FIG. 3 is a cross-sectional view of the rotating blade of FIG. 2 including a leading edge region.

FIG. 4 is perspective view of a portion of the leading edge region of FIG. 3 including a plurality of film holes filled with porous material.

FIG. 5 is a view of the leading edge region of FIG. 4 taken along section 5-5 illustrating an angled disposition of the film holes.

FIG. 6 is a cross-sectional view of an alternative rotating blade of FIG. 2 having a porous leading edge region.

FIG. 7 is a perspective view of a portion of the porous leading edge region of FIG. 6.

FIG. 8 is a flow chart illustrating a method of providing a cooling film along the leading edge region of the airfoil.

### DESCRIPTION OF EMBODIMENTS OF THE INVENTION

The described embodiments of the present invention are directed to a blade for a gas turbine engine. For purposes of illustration, the present invention will be described with respect to the blade for an aircraft gas turbine engine. It will be understood, however, that the invention is not so limited and may have general applicability within an engine, including compressors, as well as in non-aircraft applications, such as other mobile applications and non-mobile industrial, commercial, and residential applications. Additionally, the aspects will have applicability outside of a blade, and can extend to any engine component requiring cooling, such as a vane, shroud, or a combustion liner in non-limiting examples.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine or being relatively closer to the engine outlet as compared to another component.

Additionally, as used herein, the terms “radial” or “radially” refer to a dimension extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present invention, and do not create limitations, particularly as to the position, orientation, or use of the invention. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

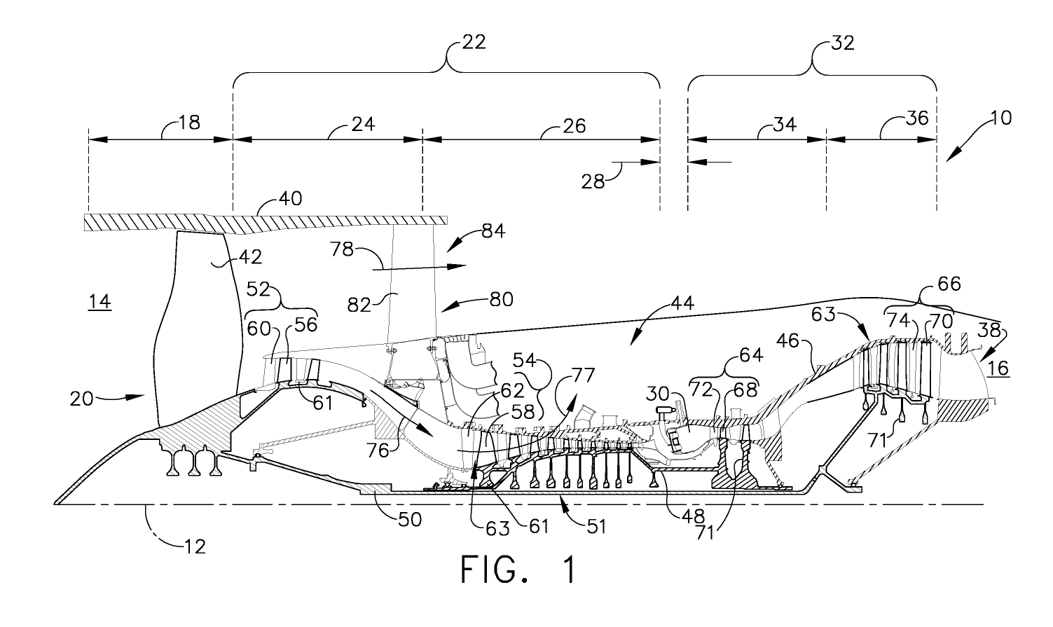

FIG. 1 is a schematic cross-sectional diagram of a gas turbine engine 10 for an aircraft. The engine 10 has a generally longitudinally extending axis or centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12. The HP compressor 26, the combustor 30, and the HP turbine 34 form a core 44 of the engine 10, which generates combustion gases. The core 44 is surrounded by core casing 46, which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The spools 48, 50 are rotatable about the engine centerline and couple to a plurality of rotatable elements, which can collectively define a rotor 51.

The LP compressor 24 and the HP compressor 26 respectively include a plurality of compressor stages 52, 54, in which a set of compressor blades 56, 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating blades 56, 58. It is noted that the number of blades, vanes, and compressor stages shown in FIG. 1 were selected for illustrative purposes only, and that other numbers are possible.

The blades 56, 58 for a stage of the compressor can be mounted to a disk 61, which is mounted to the corresponding one of the HP and LP spools 48, 50, with each stage having its own disk 61. The vanes 60, 62 for a stage of the compressor can be mounted to the core casing 46 in a circumferential arrangement.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

The blades 68, 70 for a stage of the turbine can be mounted to a disk 71, which is mounted to the corresponding one of the HP and LP spools 48, 50, with each stage having a dedicated disk 71. The vanes 72, 74 for a stage of the compressor can be mounted to the core casing 46 in a circumferential arrangement.

Complementary to the rotor portion, the stationary portions of the engine 10, such as the static vanes 60, 62, 72, 74 among the compressor and turbine section 22, 32 are also referred to individually or collectively as a stator 63. As such, the stator 63 can refer to the combination of non-rotating elements throughout the engine 10.

In operation, the airflow exiting the fan section 18 is split such that a portion of the airflow is channeled into the LP compressor 24, which then supplies pressurized air 76 to the HP compressor 26, which further pressurizes the air. The pressurized air 76 from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

A portion of the pressurized airflow 76 can be drawn from the compressor section 22 as bleed air 77. The bleed air 77 can be draw from the pressurized airflow 76 and provided to engine components requiring cooling. The temperature of pressurized airflow 76 entering the combustor 30 is significantly increased. As such, cooling provided by the bleed air 77 is necessary for operating of such engine components in the heightened temperature environments.

A remaining portion of the airflow 78 bypasses the LP compressor 24 and engine core 44 and exits the engine assembly 10 through a stationary vane row, and more particularly an outlet guide vane assembly 80, comprising a plurality of airfoil guide vanes 82, at the fan exhaust side 84. More specifically, a circumferential row of radially extending airfoil guide vanes 82 are utilized adjacent the fan section 18 to exert some directional control of the airflow 78.

Some of the air supplied by the fan 20 can bypass the engine core 44 and be used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

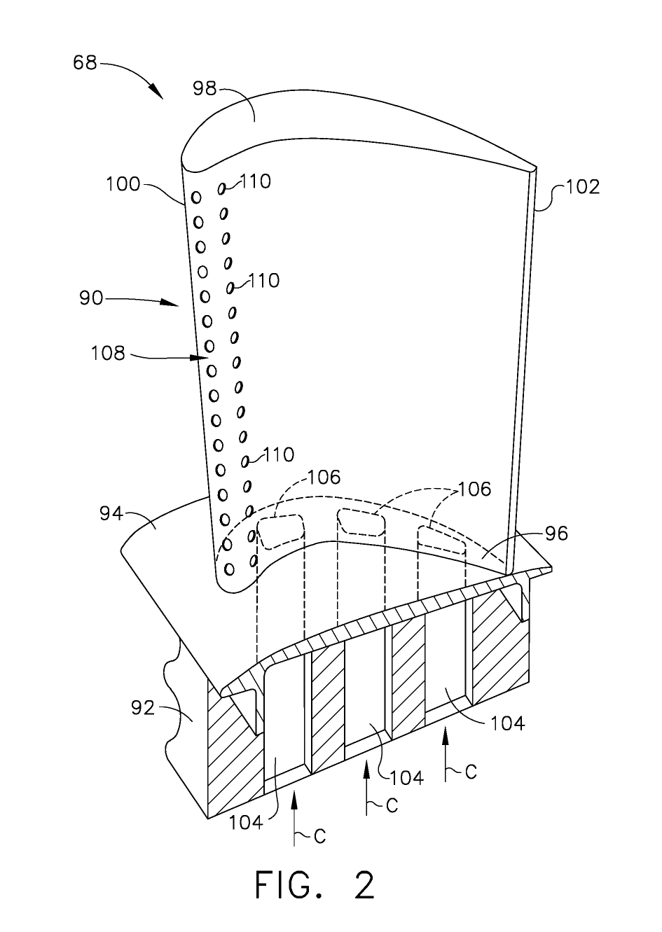

Referring now to FIG. 2, an engine component is shown in the form of an airfoil 90, which can be one of the turbine blades 68 of the engine 10 of FIG. 1. Alternatively, the engine component can include a vane, a shroud, or a combustion liner in non-limiting examples, or any other engine component that can require or utilize cooling. The airfoil 90 includes a dovetail 92 and a platform 94. The airfoil 90 extends radially between a root 96 and a tip 98 defining a span-wise direction. The airfoil 90 extends axially between a leading edge 100 and a trailing edge 102 defining a chord-wise direction. The dovetail 92 can be integral with the platform 94, which can couple to the airfoil 90 at the root 96. The dovetail 92 can be configured to mount to a turbine rotor disk on the engine 10. The platform 94 helps to radially contain the turbine airflow. The dovetail 92 comprises at least one inlet passage, shown as three inlet passages 104, each extending through the dovetail 92 in fluid communication with the airfoil 90 at a passage outlet 106. It should be appreciated that the dovetail 92 is shown in cross-section, such that the inlet passages 104 are housed within the dovetail 92.

A cooling region, shown as a leading edge region 108, defines a portion of the engine component, which requires cooling. The leading edge region 108 can be defined extending along the leading edge 100, extending at least partially between the root 96 and the tip 98. A plurality of holes, such as film holes 110, can be provided in the leading edge cooling region 108. During operation of the gas turbine engine, a hot fluid flow H drives the blades to drive the compressor section of the engine. The combined core flow and exhaust momentum generate thrust. The hot fluid flow H is often of an excessive temperature to maximize engine thrust. A cooling fluid flow C is provided to the airfoil 90 for cooling. The cooling fluid flow C can be exhausted through the film holes 110 in the leading edge region 108 to cool the leading edge of the airfoil 90.

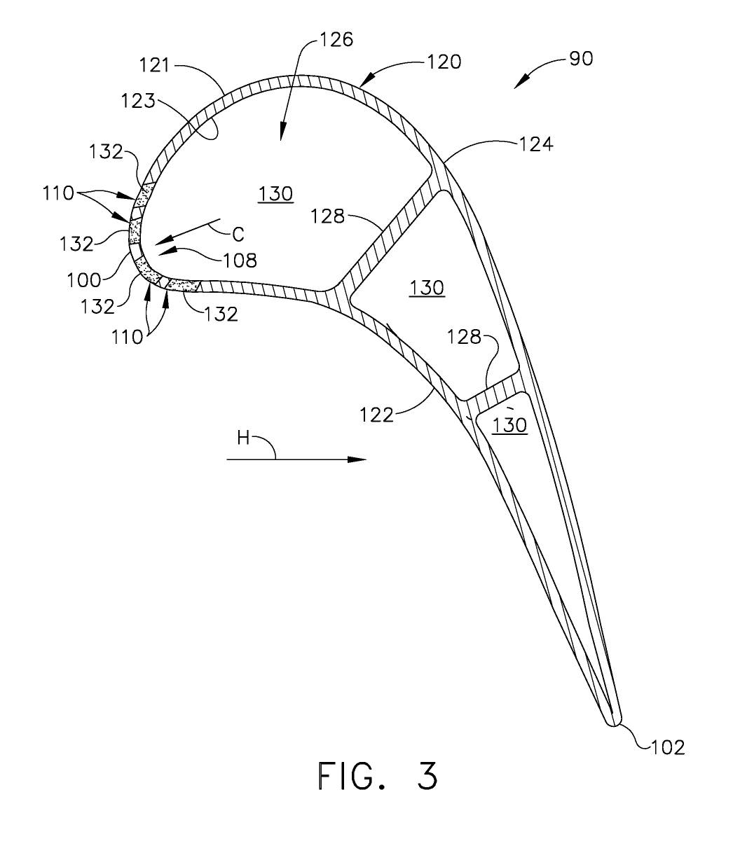

Referring now to FIG. 3, a cross-sectional view of the airfoil 90 illustrates an outer wall 120 including a pressure side 122 and a suction side 124 extending between the leading edge 100 and the trailing edge 102. The outer wall 120 separates the hot fluid flow H external of the airfoil 90 from the cooling fluid flow C within the airfoil 90, having a hot surface 121 along the exterior of the airfoil 90 and a cooling surface 123 confronting the cooling fluid flow C. An interior 126 of the airfoil 90 is defined by the outer wall 120. One or more internal ribs 128 separates the interior 126 into passages 130 extending in the span-wise direction. The passages 130 can define one or more cooling circuits throughout the airfoil 90. Additionally, the cooling circuits can be further includes micro-circuits, sub-circuits, near wall cooling circuits, leading edge passages, trailing edge passages, pin fins, pin banks, additional passages 130, flow enhancers such as turbulators, or any other structures which can define the cooling circuits.

The cooling region or leading edge region 108 can be disposed at least partially within the pressure side 122 and the suction side 124, and can be symmetric about the leading edge 100. Alternatively, the cooling region or leading edge region 108 can be asymmetric about the leading edge 100, having a larger portion on either the pressure or suction side 122, 124, or having a unique shape. Additionally, it is contemplated that the cooling region or leading edge region 108 can be disposed entirely on the pressure side 122 or the suction side 124 terminating at or near the leading edge 100 that requires cooling such as a film cooling during engine operation.

The cooling region or leading edge region 108 can be a portion of the outer wall 120 requiring cooling at, adjacent to, or near the leading edge 100. The cooling region can be any shape or size, having any geometry. The cooling region can extend at least partially in the span-wise direction between the root and the tip, and can extend fully between the root and the tip. The cooling region can extend along the outer wall 120 in the axial, or chord-wise, directions for any length such that cooling is needed such as film cooling in one example.

A porous material 132 can be provided in the film holes 110. The porous material 132 can be made by additive manufacturing, while it is contemplated that additive manufacturing can form the entire airfoil 90. It should be appreciated that any portion of the airfoil 90 can be made by any known method including but not limited to, casting, machining, additive manufacturing, coating, or otherwise. The porous material 132 can define a porosity, being permeable by a volume of fluid, such as air. The porous material 132 can have a particular porosity to meter the flow of a fluid passing through the porous material 132 at a predetermined rate. It should be appreciated that additive manufacturing can be used to achieve a particular local porosity along the porous material 132, as well as a consistent porosity across the entirety of the porous material 132, as compared to traditional method of forming the porous material 132. In alternative examples, the porous material 132 can be made of any of the methods described above, such that a porosity is defined. In one non-limiting example, the porous material 132 can be made of Ni, NiCrAlY, NiAl, or similar materials. The porous material 132 can further be made of a nickel foam, for example.

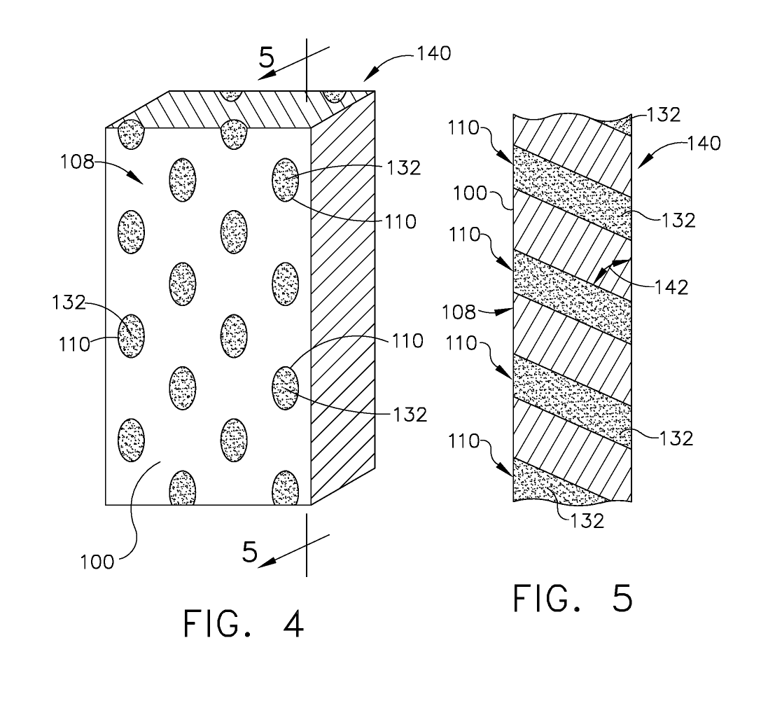

Referring now to FIG. 4, a perspective view of a portion 140 of the leading edge region 108 includes a plurality of film holes 110 having the porous material 132 filling the film holes. The film holes 110 can be organized within the leading edge region 108. Such an organization, for example, can be rows of film holes 110 extending in the span-wise direction. In other examples, the film holes 110 can be organized into patterns, groups, rows, columns, clusters, or can be based upon the particular needs of the airfoil 90, such as areas requiring more or less cooling or are more or less susceptible to thermal aggregation.

Referring to FIG. 5, taken across section 5-5 of FIG. 4, the film holes 110 are disposed at an angle 142 relative to the surface of the outer wall 120. The angle 142 is measured radially with respect to the engine centerline 12, or in the span-wise direction relative to the airfoil 90. The angle 142, for example, can be between 15-degrees and 30-degrees, and can be 20-degrees in one non-limiting example. Alternatively, it is contemplated that the angle 142 can be between 1-degree and 45-degrees. It should be appreciated that the smaller value for the angle 142 can provide for improved surface cooling along the leading edge region 108. Additionally, it should be understood that while the angles 142 are shown in the span-wise direction, they can be formed in any direction, such as span-wise, chord-wise, radial, axial, or any combination thereof in three-dimensional space.

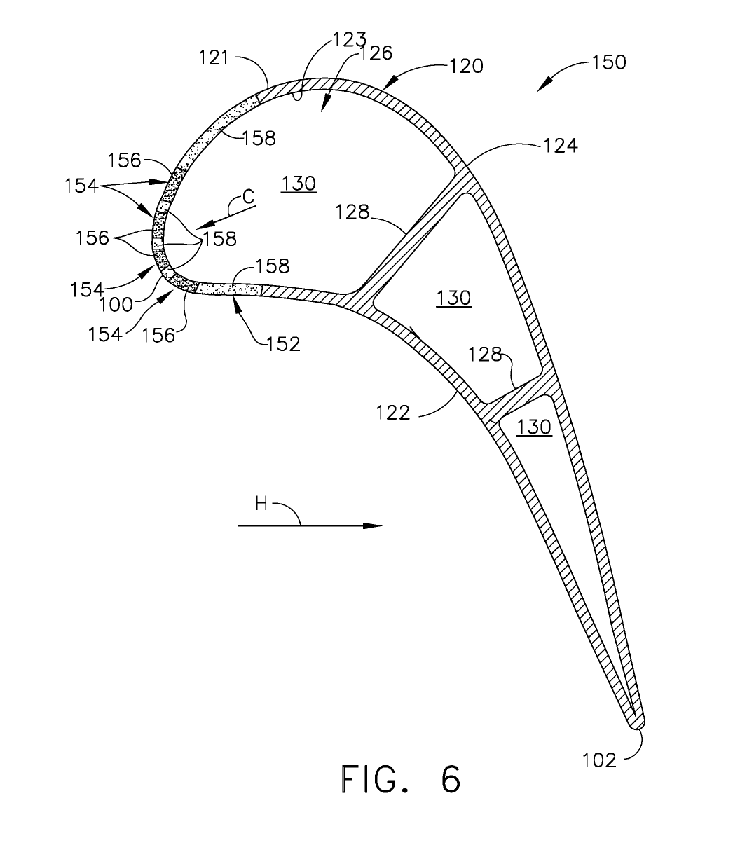

Referring now to FIG. 6, a cross-section of an alternative airfoil 150 is shown having a cooling region 108 illustrated as a leading edge region 152 with a plurality of film holes 154. A first porous material 156 fills the film holes 154. A second porous material 158 forms the leading edge region 152.

It should be understood that the first porous material 156 can fill some or all of the film holes 154 within the leading edge region 152. Additionally, the second porous material 158 can form a portion of the leading edge region 152, or the entirety of the leading edge region 152. The first porous material 156 can have a greater porosity than the second porous material 158. In one non-limiting example, the first porous material 156 can have a porosity up to one-hundred times the porosity of the second porous material 158. The first and second porous materials 156, 158 can be formed similar to the porous material 132 as discussed regarding FIG. 3, such as by additive manufacturing, while it is further contemplated that additive manufacturing forms the entire airfoil 150 or engine component. Alternatively, it is contemplated that one of the first or second porous material 156, 158 is formed by additive manufacturing while the other is formed by other manufacturing methods, such as with a nickel foam.

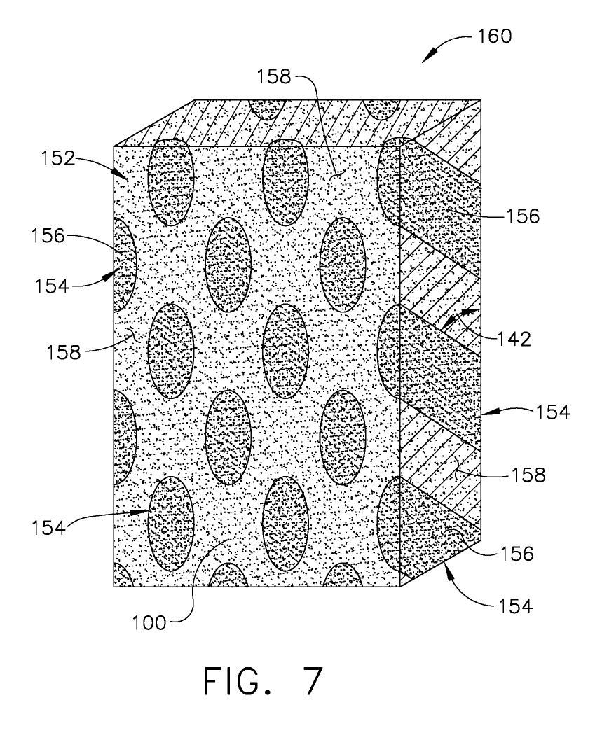

Referring now to FIG. 7, a portion 160 of the leading edge region 152 is illustrated including a pattern of the film holes 154. The pattern can be any organization of the film holes 154, such as parallel rows or columns, groups, sets, or clusters in non-limiting examples. The film holes 154 can be disposed at the angle 142 to provide a cooling fluid at an angle along the leading edge region 152.

It should be understood that the porous materials described herein, such as the porous material 132 of FIGS. 3-5 or the porous materials 156, 158 of FIGS. 6-7 can be a structured porous material or a random porous material, or any combination thereof. A structured porous material includes a structured, determinative porosity throughout the material, which can have particular local increases or decreases in porosity to meter a flow of fluid passing through the structured porous material. In another example, a structured porous material can include a porous material having a non-random arrangement. Such local porosities can be determined and controlled during manufacture. Additive manufacturing can be used to form a structured porous material, in one non-limiting example. Alternatively, the porous materials can have a random porosity. The random porosity can be adapted to have a porosity as the average porosity over an area of the porous material, having discrete variable porosities that are random. A random porous material can be made from a nickel foam, in one non-limiting example.

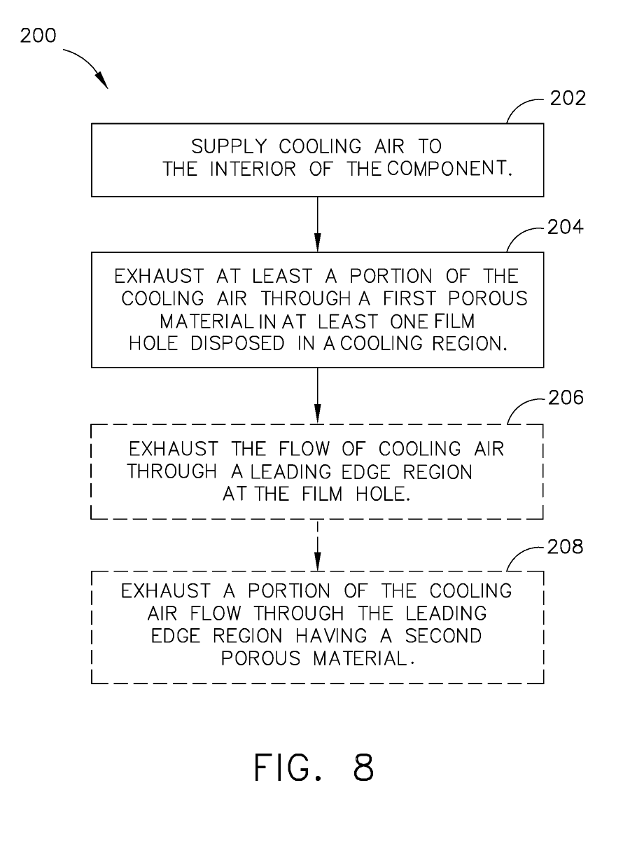

Referring now to FIG. 8, a method 200 of providing a cooling film along a leading edge region of an airfoil for a turbine engine can include: at 202, (1) providing a flow of cooling fluid to the interior of the airfoil; and, at 204, (2) exhausting at least a portion of the cooling fluid through a first porous material in at least one film hole disposed in a cooling region. Alternatively, the method 200 can include, at 206, exhausting the flow of cooling air through a leading edge region at the film hole. Additionally, the method can include, at 208, exhausting a portion of the cooling fluid flow through the leading edge region having a second porous material.

At step 202, a flow of cooling fluid C can be provided to the interior such as shown in FIG. 2, having the cooling flow provided through inlet passages in the dovetail. At step 204, the cooling fluid is exhausted through a first porous material in at least one film hole in the cooling region. such as the leading edge regions 108, 152 of FIGS. 2 and 6, for example. As such, the component can be an airfoil, such as the airfoil described herein, with the cooling region being the leading edge region near or at the leading edge of the airfoil. At step 206, the cooling air can be exhausted through the leading edge region at the film holes, through the first porous material in the film holes. As the flow of cooling fluid C passes through the porous material, the porosity or local porosities can particularly meter or direct the flow of cooling fluid C through the porous material. As such, the required flow of cooling fluid can be reduced to improve efficiency. Additionally, at step 208, the leading edge region 152 can include the porous material, such as the second porous material 158. A portion of the cooling fluid flow exhausts through the leading edge region 152, such as through the second porous material 158, as well as the first porous material in the film holes. The porosity of the leading edge region 152 can be less than that of the first porous material 132, 156 disposed in the film holes, permitting greater flow rates of the cooling fluid passing through the film holes.

It is contemplated that the porous material, the airfoils, or the other components described herein can be made with additive manufacturing. Additive manufacturing, such as 3D printing, can be used to form complex cooling circuit designs, having shaping or metering sections, complex circuits, holes, conduits, channels, or similar geometry, which is otherwise difficult to achieve with other manufacturing methods like drilling or casting. Additionally, the porous material can be formed with additive manufacturing. Typical methods for forming porous metals can result in uneven porosity among areas of the porous metals. Utilizing additive manufacturing can enable a manufacturer to achieve a uniform porosity along the entire porous structure. Alternatively, the manufacturer can achieve variable local porosities throughout the porous material as is desirable. Furthermore, such manufacturing can provide a more precisely made product, having a higher yield as compared to other manufacturing strategies.

It should be appreciated that the airfoil or engine component, utilizing porous material provides for even cooling distribution for a flow of cooling fluid. An additive manufacturing build of the regions could provide a precise distribution, particularly permitting an even porosity for the porous material(s). Additionally, the use of additive manufacturing can permit particular shaping or tailoring of the porous material or the airflow to control the flows throughout the airfoil. Utilizing such a porous material permits the flow of a fluid through the engine component, while retaining less heat to remain cooler. As such, the cooling, such as surface film cooling, provided through the walls of such engine components is enhanced. The enhanced cooling reduces the required flow of cooling fluid, such as up to 30-50% in one example. Such a reduction can increase engine efficiency. Furthermore, reduced blowing ratios can obtain better surface film cooling to increase component lifetime or reduce required maintenance.

It should be appreciated that while the description is directed toward a leading edge of the airfoil, the concepts as described herein can have equal applicability in additional engine components, such as a vane, shroud, or combustion liner in non-limiting examples, and the leading edge region can be any region of any engine component requiring cooling, such as regions typically requiring film cooling holes or multi-bore cooling. It should be further appreciated that the holes as shown are non-limiting, and can be any shape, size, orientation, or include any geometry.

It should be further appreciated that the region and film holes having the porous material can provide for improved film cooling, such as providing improved directionality, metering, or local flow rates. Additionally, the porous material include in the region and the film holes can further improve the film cooling to an entire region beyond just the areas local to the film holes.

It should be appreciated that application of the disclosed design is not limited to turbine engines with fan and booster sections, but is applicable to turbojets and turbo engines as well.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A component for a turbine engine, which generates a hot fluid flow and provides a cooling fluid flow, the component comprising:
a wall separating the hot fluid flow from the cooling fluid flow and having a hot surface facing the hot fluid flow and a cooling surface facing the cooling fluid flow;
a cooling region defined in the hot surface;
a plurality of holes extending between cooling surface and the hot surface, with at least some of the plurality of holes are located within the cooling region; and
a first porous material disposed in at least some of the plurality of holes.

2. The component of claim 1 wherein at least some of the plurality of holes are arranged in rows.

3. The component of claim 2 wherein at least some of the rows are parallel to each other.

4. The component of claim 2 wherein the rows of holes are offset from one another.

5. The component of claim 1 wherein the first porous material is disposed in all of the holes.

6. The component of claim 1 wherein the first porous material has a random porosity.

7. The component of claim 1 wherein the first porous material has a structured porosity.

8. The component of claim 1 wherein the cooling region is made of a second porous material.

9. The component of claim 8 wherein the second porous material has a porosity less than that of the first porous material.

10. The component of claim 9 wherein all of the holes within the cooling region include the first porous material.

11. The component of claim 10 wherein the first and second porous materials are made from additive manufacturing.

12. The component of claim 1 wherein the first porous material is made from additive manufacturing.

13. The component of claim 1 wherein the component is one of a blade, vane, shroud, or combustion liner.

14. An airfoil for a turbine engine, the airfoil comprising:
a perimeter wall bounding an interior and defining a pressure side and a suction side extending axially between a leading edge and a trailing edge and extending radially between a root and a tip;
a radially extending leading edge region disposed along the leading edge and at least partially extending between the root and the tip;
a plurality of film holes disposed in the leading edge region; and
a first porous material filling at least some of the film holes.

15. The airfoil of claim 14 wherein the film holes are organized in a non-random arrangement.

16. The airfoil of claim 14 wherein the leading edge region is made of a second porous material having a different porosity than the first porous material.

17. The airfoil of claim 16 wherein one of the first porous material and the second porous material has a structured porosity.

18. The airfoil of claim 17 wherein both the first and second porous materials have the structured porosity.

19. The airfoil of claim 14 wherein the leading edge region is disposed at least partially within the pressure side and the suction side.

20. The airfoil of claim 14 wherein the holes are disposed at an angle between 15 and 30 degrees relative to a span-wise direction.

21. The airfoil of claim 14 wherein the airfoil is one of a blade or vane.

22. A method of providing a cooling film along a cooling region of a component for a turbine engine, the method comprising:
supplying cooling air to an interior of the airfoil; and
exhausting at least a portion of the supplied cooling air through a first porous material in at least one film hole disposed in a cooling region.

23. The method of claim 22 wherein the component is an airfoil and the cooling region is a leading edge region.

24. The method of claim 23 further comprising exhausting a portion of the cooling air through the leading edge region surrounding the at least one film hole.

25. The method of claim 24 wherein the exhausting the cooling air from the leading edge region includes exhausting the cooling air through a second porous material.

26. The method of claim 25 wherein the porosity of the second porous material is less than the porosity of the first porous material.
